(19) United States
(12) Patent Application Publication
(10) Pub. No.: US 2012/0132634 A1
(43) Pub. Date: May 31, 2012

(54) Deicing method based on carbon/glass fiber hybrid textile

(76) Inventor: Shide Song, Dalian (CN)

(21) Appl. No.: 13/131,593

(22) PCT Filed: Nov. 29, 2009
(86) PCT No.: PCT/CN09/75201

§ 371 Date: Aug. 16, 2011

(30) Foreign Application Priority Data
Nov. 29, 2008 (CN) 200810229274.2

(51) Int. Cl. B60L 1/02

(52) U.S. Cl. 219/203

(57) ABSTRACT

The present disclosure relates to a deicing method based on carbon/glass fiber hybrid textile, with carbon fiber rovings in warp direction and AR-glass fiber rovings in weft direction; additionally, the mesh size of the textile is not less than 10 mm* 10 mm. The carbon/glass fiber hybrid textile treated with epoxy resin impregnating and sand penetration is embedded into thermal conducting layer, and carbon fiber rovings are wired to high power supply to turn electric energy into heat energy, which can melt ice and snow on the surface of thermal conducting layer when the surface temperature exceeds zero degree Celsius. In order to reduce thermal loss and make full use of thermal energy, thermal insulation layer is placed between thermal conducting layer and the substrate. The deicing temperature can be adjusted with designed temperature controller, which can optimize control parameters according to current surface temperature, wind speed, snow and ice thickness, environment temperature and expected deicing time. The carbon/glass fiber hybrid textile can realize uniform and rapid heating, and the method possesses reliable performance, strengthening and toughening substrate, low cost and long service life.

### CROSS-REFERENCE TO RELATED APPLICATIONS

This application is the U.S. national phase application of PCT International Application No. PCT/CN2009/075201, filed on Nov. 29, 2009, which claims priority to China Patent Application No. CN200810229274.2, filed on Nov. 29 2008. The above application(s) is hereby incorporated herein by reference.

### TECHNICAL FIELD

The present invention relates to a method for deicing based on carbon/glass fiber hybrid textile for transportation area to mitigate the impact of natural hazards.

### BACKGROUND OF THE INVENTION

In winter, snow and ice on pavement, bridge and airport bring inconvenience and security risks to transportation, such as traffic jams, speed restriction, full closure of the highways, flight delays and even the closure of the airports due to the snow. Besides, snow and ice also cause huge economic loss to a country. Therefore, effective measures are in urgent need to eliminate snow and ice in time to keep the traffic safe and smooth.

Traditionally, removing ice and snow from road can be accomplished by a combination of several methods, such as machine, natural melting, and chemical treatment. In most cases, snowmelt agent is used as a primary means for deicing purpose. Chloride deicing salt with advantages of low cost and good deicing performance has been widely used in the world, but the use of chloride has cause corrosion of steel bars in concrete, road surface denudation, environmental pollution and vegetation damages.

Electric heating is another method to remove ice and snow. Electric cable heating system presents poor corrosion resistance of the metal heater in concrete and the durability of heating cable under cycle impact load. In addition, the method consumes much more metal resource. In recent years, researchers tend to pay more attention to conductive concrete, which is a kind of cement-based composite material containing a certain amount of conductive components, such as steel shaving, steel fiber, carbon fiber, carbon powder, graphite, carbon black and so on. There are a certain research achievements, however, the resistance of conductive concrete is vulnerable to contact resistance, relative humidity, compactness, temperature and water ratio, which may result in instability in the application. Besides, the resistance of conductive concrete is closely related to working conditions, for example, there will be an abrupt change of resistance if the concrete cracks. That is to say, it is hard to use the method in field for the poor stability and reliability.

### SUMMARY OF THE INVENTION

Textile Reinforced Concrete (TRC) is a new high performance cementitious composite material consisting of multi-axial textile reinforcement made with advanced textile technology and fine-grained concrete. The warp and weft rovings of the textile are normally glass fiber rovings. The textile has excellent ability of directional strengthening and delaying crack. Due to the wonderful corrosion resistance of fiber materials, the concrete cover is no longer needed as a chemical protection. Experiment results showed that sticking sand on the epoxy resin-impregnated textile can make its anti-crack ability better exert and thus the crack-control and reinforcing function of TRC layer can be fully utilized, it can also applied to improve the whole mechanical behavior of structure.

It is therefore a feature of the present invention to provide an effective deicing method which can overcome the above mentioned disadvantages of the prior method.

Another feature of the present invention is to provide a new function acted as TRC to strengthen and toughen substrate, such as pavement, road and bridge.

The proposed deicing method is based on carbon/glass fiber hybrid textile with a mesh size of not less than 10 mm* 10 mm, the warp rovings of the textile are carbon fibers and weft rovings are glass fibers. Carbon fiber rovings are electric heating elements to generate Joule heating when connected to electric power, and glass fiber rovings act as a support structure to assure uniform interval between adjacent carbon fiber rovings, this means that uniform heat can be generated by the carbon fiber rovings. Except for deicing, the textile can also function like ordinary textile made of glass fiber rovings, which can be used to enhance the structure. In order to prolong the service life, AR-glass fiber rovings are used in the textile.

The whole deicing system is comprised of electric insulation layer of carbon fiber rovings, thermal conducting layer, thermal insulation layer, digital PID temperature controller and high power electrical source.

The construction process are described below: the layers from bottom to top are as follows: substrate, thermal insulation layer and thermal conducting layer, the carbon/glass fiber hybrid textile treated with epoxy resin impregnating and sand penetration is heating layer, which is tiled in the thermal conducting layer, with the warp carbon fiber rovings parallel to the short axis of the heated object and weft AR-glass fiber rovings parallel to the long axis. Temperature probes are integrated in the thermal conducting layer. After completion of heating structure, the carbon fiber rovings are wired to power supplies by way of series-parallel connection. Because carbon/glass fiber hybrid textile is a planar mesh fabric, it is easy to handle on field.

Control parameters, such as the real-time temperature of the top layer, wind speed over the surface, snow and ice thickness on the surface, environment temperature, are fed into a special designed temperature controller, then the optimized heating power generated by the carbon fiber rovings can efficiently melt the snow and ice on the surface with lower costs.

The Benefits of the Invention are:

Compared with heating cable technology, the deicing method based on carbon/glass fiber hybrid textile has advantages of high tensile strength, lightweight, corrosion resistance, fatigue resistance, long lifetime, low costs and simple construction process. A stable conduction system with evenly spaced groupings of carbon fiber rovings can be formed to improve the heating efficiency and temperature uniformity.

Unlike the deicing method based on conductive concrete, the conductivity and heating power are hardly affected by temperature of concrete, compactness, water ratio and concrete cracking, so this method shows high reliability and good economic benefit. Besides, the treated carbon/glass fiber hybrid textile can strengthen matrix and prolong service life.

As described above, the deicing method based on carbon/glass fiber hybrid textile is an ideal technology for melting snow and ice in urban roads, airport runways, expressways, bridge decks, sidewalks or somewhere like that.

### BRIEF DESCRIPTION OF THE DRAWINGS

FIG. 1 is a schematic view of deicing system based on carbon/glass fiber hybrid textile.

FIG. 2 is a schematic view of carbon/glass fiber hybrid textile.

FIG. 3 is a side view of carbon/glass fiber hybrid textile treated with epoxy resin impregnating and sand penetration.

FIG. 4 is an electric schematic of deicing system used in the test.

FIG. 5 shows temperature curve of a test slab.

FIG. 6 shows resistivity curve of a test slab.

### DRAWINGS—REFERENCE NUMERALS

01 carbon/glass fiber hybrid textile
02 substrate
03 thermal insulation layer
04 thermal conducting layer
05 temperature sensor
06 electric terminals of carbon fiber rovings
07 power supply
08 temperature control system
09 carbon fiber rovings
10 AR-glass fiber rovings
11 epoxy resin layer
12 sand penetration layer

### DETAILED DESCRIPTION

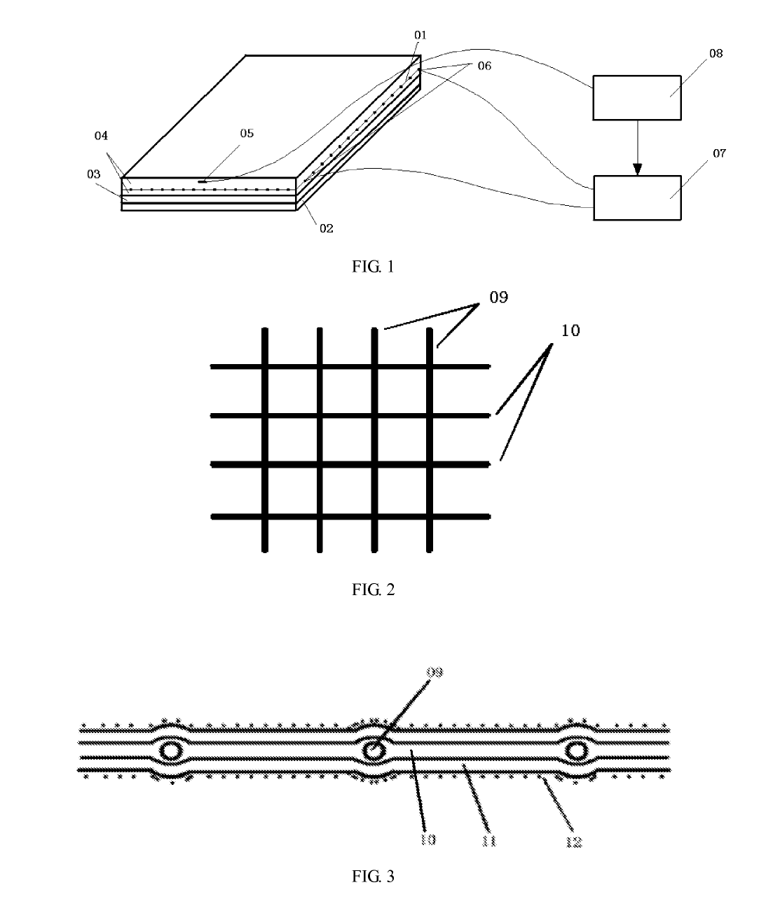

The present disclosure relates to a deicing method based on carbon/glass fiber hybrid textile 01, as shown in FIG. 1. Carbon/glass fiber hybrid textile 01 is shown in FIG. 2, with carbon fiber rovings 09 in warp direction and AR-glass fiber rovings 10 in weft direction. Here, carbon fiber rovings 09 are electric heating elements. The carbon/glass fiber hybrid textile 01 is treated with epoxy resin impregnating 11 and sand penetration 12, as shown is FIG. 3.

The Construction Process is as Follows:

As shown in FIG. 1, the bottom layer is thermal insulation layer 03 with thickness of 10˜30 mm, which is laid on the substrate 02 to reduce thermal loss and make full use of power.

As shown in FIG. 1, above the thermal insulation layer 03, a thermal conducting layer 04 is installed. The treated carbon/glass fiber hybrid textile 01 is tiled in the thermal conducting layer 04, with the warp carbon fiber rovings 09 parallel to the short side of the structure, Temperature sensor 05 is embedded in the upper part of thermal conducting layer 04. Considering thermal-transfer rate and the power assumption of the deicing system, the thickness of thermal conducting layer 04 ranges from 20 to 50 mm.

As shown in FIG. 1, after construction, electric terminals 06 on both sides of the carbon fiber rovings 09 are wired to a power supply 07 by way of series, parallel and series-parallel combined connection. The heating power is controlled by a special designed temperature control system 08. The deicing temperature can be adjusted in real time according to current surface temperature, wind speed, snow and ice thickness, environment temperature and expected deicing time. Based on carbon/glass fiber hybrid textile, the deicing system can realize uniform and rapid deicing.

Small-scale heating tests using 400*400*40 mm³ slab are conducted. The slab is composed of three layers: bottom layer of 30 mm thick concrete, middle layer of treated carbon/glass fiber hybrid textile with mesh size of 10 mm* 10 mm, top layer of 10 mm thick concrete. During the experiment, styrofoam of 30 mm thickness is used as thermal insulation layer under the slab. A temperature probe is embedded in the upper side of the slab.

The average resistance of single carbon fiber roving is 24.5 Ω, and the total resistance of the slab is approximately 0.74 Ω in parallel connections and 784.06 Ω in series connections. The total heating resistance ranges from 0.74 to 784.06 Ω by changing the connection.

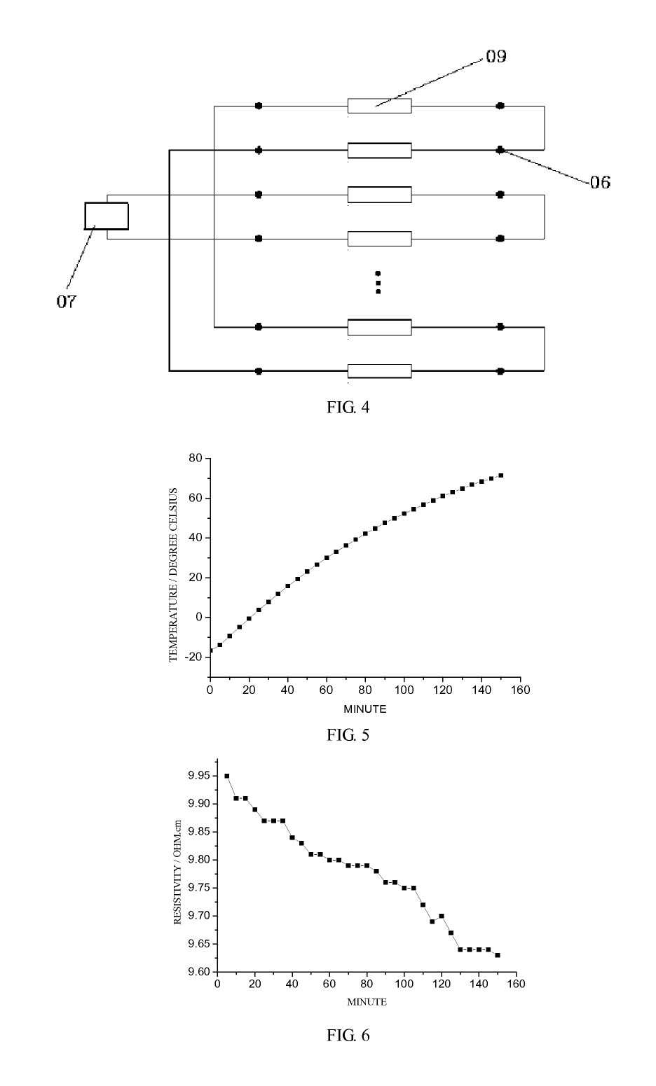

During the test, the carbon fiber rovings were connected to DC power supply of 24V/15A in a series-parallel connection, as shown in FIG. 4. The slab was put into a freezer to make ambient temperature constantly. When the slab was powered, the slab temperature raised from −16.6 to 71.5 degree Celsius in 150 minutes, with the average heating rate of 0.59 degree Celsius per minute, as shown in FIG. 5. During heating operation, the heating resistivity of the slab decreased from 9.95 to 9.75 Ω·cm with a maximum decreasing amplitude of 2.01%, as shown in FIG. 6, this means that the heating resistance is stable over heating period with large temperature.

The real-time surface temperature of thermal conducting layer, together with wind speed, snow and ice thickness, environment temperature and expected deicing time are used in designed temperature control system to effectively adjust the heating power of carbon/glass fiber hybrid textile.

The mesh size of the textile and sectional dimension of carbon fiber rovings are related to the matrix and deicing requirements, but considering the heating efficiency and fabrication cost, the minimum mesh size should be not less than 10 mm* 10 mm. Epoxy resin impregnating treatment can not only improve the harmonious bearing capacity of filaments, but also play an important role on electrical insulation. Besides, sand penetration can further improve the bond properties of the textile and has remarkable effect on strengthening and toughening.

We claim:

1. A method of deicing and snow melting, comprising: carbon/glass fiber hybrid textile with mesh size of not less than 10 mm* 10 mm, composed of carbon fiber rovings in warp direction and AR-glass fiber rovings in weft direction, thermal insulation layer, thermal conducting layer, temperature controller, power supply. Thereby, the method has the following characteristics: the carbon/glass fiber hybrid textile treated with epoxy resin impregnating and sand penetration is tiled into thermal conducting layer, carbon fiber rovings are wired to a high power supply to turn electric energy into heat energy to melt ice and snow on the surface of thermal conducting layer. In order to reduce thermal loss and make full use of electric power, thermal insulation layer is placed between thermal conducting layer and the substrate.
